(19) United States
(12) Patent Application Publication
(10) Pub. No.: US 2020/0310364 A1
(43) Pub. Date: Oct. 1, 2020

(54) CONTROL DEVICE, CONTROL METHOD, AND PROGRAM

(71) Applicants: Hirochika Asai, Tokyo-to (JP); Yusuke Doi, Tokyo-to (JP); Yuzo Tamada, Tokyo-to (JP)

(72) Inventors: Hirochika Asai, Tokyo-to (JP); Yusuke Doi, Tokyo-to (JP); Yuzo Tamada, Tokyo-to (JP)

(73) Assignee: Preferred Networks, Inc., Tokyo-to (JP)

(21) Appl. No.: 16/898,730

(22) Filed: Jun. 11, 2020

Related U.S. Application Data
(63) Continuation of application No. PCT/JP2018/045878, filed on Dec. 13, 2018.

(30) Foreign Application Priority Data
Dec. 13, 2017 (JP) 2017-238384

(51) Int. Cl. G05B 13/02; G05B 23/02; H04L 29/08; G06N 20/00

(52) U.S. Cl. CPC G05B 13/0205; G05B 13/0265; G06N 20/00; H04L 67/125; G05B 23/0259

(57) ABSTRACT

In a combination of diverse devices, system control with high real-time property is realized. A control device includes: a control indication acceptor receiving a control target indication to be a target of control with respect to plural controlled devices; and a control processing generator generating a control signal with respect to each of the plural controlled devices based on the control target indication, in which operations of the plural controlled devices are controlled so that the plural controlled devices cooperate to achieve the target, based on at least one of a communication delay time, a phase shift time, and an operation cycle time of the plural controlled devices.

### CROSS REFERENCE TO RELATED APPLICATIONS

This application is continuation application of International Application No. JP2018/045878 filed on Dec. 13, 2018, which claims priority to Japanese Patent Application No. 2017-238384 filed on Dec. 13, 2017, the entire contents of which are incorporated herein by reference.

### FIELD

The present disclosure relates to a control device, a control method, and a program.

### BACKGROUND

In order to realize a critical system such as factory automation, there exist communication required to have a real-time property which is, for example, communication for real-time device control, safety, security, and so on, and the other communication which is, for example, communication for indicating the next target to a device, maintenance telemetry, and so on. As an example of performing control through these communications, there can be cited one in which communications are classified into real-time communication and non-real-time communication, and the real-time communication and the non-real-time communication are made to coexist by preferentially executing transmission and reception related to the real-time communication. As another example, by assuming an environment in which arbitrary plural control devices and sensors are combined by software in order to perform flexible processing, there can be cited a system including at least one cooperation control apparatus for performing control to make the whole cooperate.

However, in a task executed by plural control devices, controlled devices, sensors, and a combination thereof, there are respectively different time cycles. For example, there is a case in which, between the control device and the controlled device, communication is performed once per 4 milliseconds since control with high real-time property is required, and meanwhile, an information acquisition cycle of the sensor is once per 16.67 milliseconds, and since the control device for performing estimation based on deep learning is required to perform complicated calculation, only one time of processing and indication per 200 milliseconds can be made. In such a case, a method of smoothly executing control by combining individually different control cycles, is not obvious. Further, even if each of the plural controlled devices has the same cycle, it is not always operated at the same timing, so that it is also difficult to make these devices cooperate smoothly. Besides, in an environment where cycles are synchronized, it is possible to execute scheduling of the real-time communication and the non-real-time communication. However, in real devices, there are restrictions such that operation cycles are not unified, or even if the operation cycles are the same, they are not synchronized. Further, in a conventional system, a communication delay is not taken into consideration, and when there exist a delay and jitter (delay fluctuation) of a communication device, the real-time property cannot be realized.

### BRIEF DESCRIPTION OF DRAWINGS

FIG. 1 is a block diagram illustrating a configuration of a system according to one embodiment;

FIG. 2 is a block diagram illustrating a configuration of a control device according to one embodiment;

FIG. 3 is a flow chart illustrating a flow of processing of the control device according to one embodiment;

FIG. 4 is a flow chart illustrating processing of a system including the control device according to one embodiment;

FIG. 5 is a flow chart according to another example of FIG. 4;

FIG. 6 is a diagram illustrating pseudo-codes defining an operation of the control device according to one embodiment;

FIG. 7 is a diagram illustrating pseudo-codes according to another example of FIG. 6;

FIG. 8 is a block diagram illustrating an example of implementation according to one embodiment; and

FIG. 9 is a diagram illustrating an example of implementation according to one embodiment.

### DETAILED DESCRIPTION

According to some embodiments, a control device includes: a control indication acceptor receiving a control target indication to be a target of control with respect to plural controlled devices; and a control processing generator generating a control signal with respect to each of the plural controlled devices based on the control target indication, in which operations of the plural controlled devices are controlled so that the plural controlled devices cooperate to achieve the target, based on at least one of a communication delay time, a phase shift time, and an operation cycle time of the plural controlled devices.

Accordingly, the present disclosure provides control with high real-time property in a system in which plural devices are combined.

A control device according to one embodiment includes: a control indication acceptor receiving a control target indication to be a target of control with respect to plural controlled devices; and a control processing generator generating a control signal with respect to each of the plural controlled devices based on the control target indication, in which operations of the plural controlled devices are controlled so that the plural controlled devices cooperate to achieve the target, based on at least one of a communication delay time, a phase shift time, and an operation cycle time of the plural controlled devices.

Hereinafter, embodiments of the present disclosure will be described in more detail while referring to the drawings. The present embodiment does not limit the present disclosure. Note that in the respective drawings, components having equivalent functions are denoted by the same reference numerals, and detailed explanation of the same component is not repeated. Further, in the following description, numeric values of a period of time taken for one cycle of processing, a delay time, a phase shift time, and so on are expressed as one example for explanation, and are not actual numeric values. For this reason, even if they are other numeric values, it is possible to perform processing similarly to the present embodiment.

A cooperation control apparatus according to the present disclosure prescribes an operation in the worst case, and normally, it constructs a flexible application while maintaining a firm real-time characteristic of performing scheduling that meets deadline. For this reason, a DSL (Domain-Specific Language) for stream processing that constructs application logic is employed.

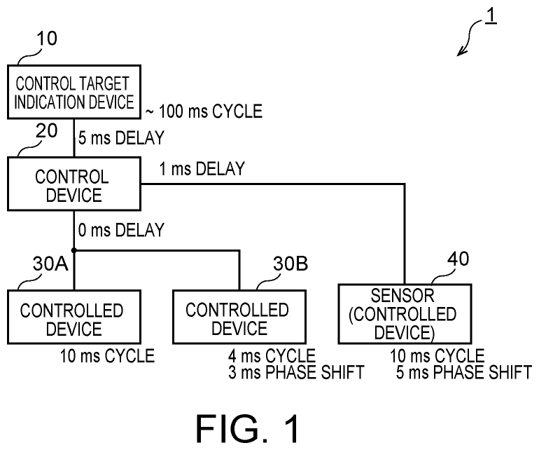

FIG. 1 is a block diagram illustrating a configuration of a system that is controlled by a cooperation control apparatus according to the present embodiment. A system 1 includes a control target indication device 10, a control device 20, a controlled device 30A, a controlled device 30B, and a sensor 40. Note that although the number of controlled devices is set to two as an example, the number of controlled devices may also be a plural number larger than two. Further, the sensor 40 may also be a controlled device that is controlled by the control device 20.

These respective devices are mutually connected by a communication path utilizing Internet, Ethernet (registered trademark), or the like. This connecting method is not limited to wire connection, and wireless connection may also be employed. Further, a protocol and a system are not particularly limited, and any connecting method enabling proper communication of signals may be employed. A delay in communication from the control device 20 to each device may exist.

The control target indication device 10 is a device that indicates, to the control device 20, a target regarding what kind of control is performed. The indication of target means, for example, to indicate a target regarding what kind of operation is performed by each of the controlled devices 30 based on a machine-learned model formed in the control target indication device 10, or regarding how the controlled devices 30 are operated after taking feedback information from these controlled devices 30 or a state acquired by the sensor 40 in the model, and the control target indication device 10 is a device that indicates the targets. For the machine learning, it is also possible to use processing that takes time longer than that of the other processing, such as deep learning.

An example of more concrete indication of target includes, in an indication related to an industrial robot, a series of operations of respective arms required for cooperative control such that plural arms are used to grip one object, lift the object, and then a jig is disposed below the lifted object by using an arm other than the plural arms.

This processing conducted in the control target indication device 10 is processing that relatively takes time in which, for example, the next indication target is acquired by performing the machine learning, or from the machine-learned model as described above, so that the processing is set to be executed in a cycle of 100 milliseconds. A communication delay between the control target indication device 10 and the control device 20 is set to 5 milliseconds, for example.

Note that although there is only one control target indication device 10 in FIG. 1, the present embodiment is not limited to this, and it is also possible to provide plural control target indication devices 10. In this case, each of the control target indication devices 10 has the above-described cycle, delay, and so on.

The control device 20 is a device that transmits, to each of the controlled devices 30, a control signal with respect to each of the devices, in accordance with the indication of control target acquired from the control target indication device 10. Besides, the control device 20 receives information from each of the controlled devices 30 and the sensor 40, and generates the control signal based on the received state. Further, at this time, it is also possible to design such that the control device 20 transmits the state acquired from each of the controlled devices 30 and the sensor 40 to the control target indication device 10, and then it acquires the control target indication.

The controlled device 30 performs an operation based on the control signal received from the control device 20. In the above-described example, the controlled device 30 corresponds to each arm, and it grips the object or dispose the jig below the object which is being gripped based on the control signal generated by the control device 20.

The plural controlled devices 30 operate based on respective operation cycles. Further, each of the controlled devices 30 may have a communication delay from the control device 20. Further, not all of the respective controlled devices 30 operate in a synchronized manner, the operation cycles are different as described above, and in addition to that, there exist phase shifts when the respective controlled devices 30 operate. When, for example, the respective controlled devices 30 simultaneously receive a control instruction from the control device 20, periods of time taken for starting the operation are sometimes different, and an offset indicating the time deviation is the phase shift.

The controlled device 30 follows the control instruction from the control device 20, and performs an operation in its own operation cycle. Besides, the controlled device 30 may also be designed to give feedback, to the control device 20, on a signal indicating that the operation is performed. Further, as another example, when the controlled device 30 waits an operation or is able to receive a control instruction (in an idle state), it may also transmit the state to the control device 20.

The sensor 40 is, for example, a camera that photographs a state of the controlled device 30. The sensor 40 may also be, other than the camera, a vibration sensor that measures vibration, a sound perception sensor that measures sound, a temperature or humidity sensor that measures temperature or humidity, or a pressure sensitive sensor. The sensor 40 may be a sensor that senses a state of the controlled device 30 to be required. Further, the sensor 40 itself may also be the controlled device 30 that is controlled by the control device 20.

When the sensor 40 is the camera, it photographs the state of the controlled device 30 in a predetermined cycle which is, for example, a cycle of 10 milliseconds, and transmits the state to the control device 20. The control device 20 generates the next control signal to be transmitted to the controlled device 30, based on not only a feedback signal from the controlled device 30 but also an image photographed by the sensor 40 and a control target value received from the control target indication device 10.

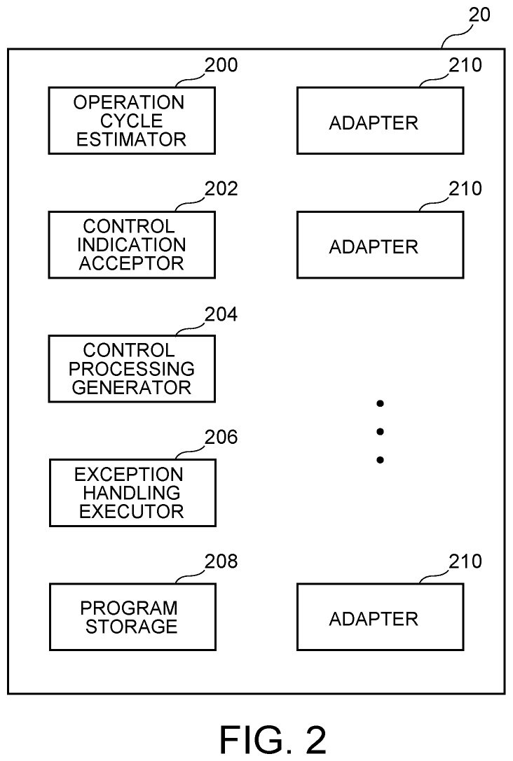

FIG. 2 is a block diagram illustrating a configuration of the control device 20. The control device 20 is configured by including an operation cycle estimator 200, a control indication acceptor 202, a control processing generator 204, an exception handling executor 206, a program storage 208, and adapters 210.

The operation cycle estimator 200 estimates an operation cycle of each of the controlled devices 30, the sensor 40, and the control target indication device 10. The operation cycle of each device is estimated by a timing at which a reply to an instruction from the control device 20 is sent, for example. A control cycle of the controlled device 30 or the like may also be given beforehand. In this case, for example, an instruction to send a reply is issued, and based on a timing at which the reply to the instruction is received from the controlled device 30 or the like, a timing deviation (offset) can be estimated.

Further, each of the controlled devices 30 has a decided timing at which a reply to the signal can be made in the cyclic operation operated by loop processing, so that it becomes possible to estimate an offset from when the control device 20 transmits the signal to when the controlled device 30 starts an operation. Specifically, by reading the timing of reply decided for each device, a timing deviation between the control device 20 and the controlled device 30 and between the plural controlled devices 30 is estimated. Note that in this case, the operation cycle of each of the controlled devices 30 may also be given based on a catalog value or the like, and it is also possible that the operation cycle is also estimated by the operation cycle estimator 200 as described above.

Even in a case where the reading cannot be performed from one reply timing, by issuing an instruction as described above plural times at different timings, and taking a timing at which a reply is received into consideration, it becomes possible to determine the offset. Here, the offset means a value indicating a deviation of the operation cycle of each of the controlled devices 30 when seen from the control device 20.

Further, as another example, an instruction to send a reply is issued to the control target indication device 10 or the controlled device 30 at fixed intervals, for example, every 1 millisecond, and it is possible to perform estimation based on which timing the reply to this instruction is sent or how many instructions are collectively replied. By measuring the reply timing as described above, even when the operation cycle of each of the controlled devices 30 is unknown, for example, this operation cycle itself can be estimated.

When the cycle is estimated beforehand, the estimation can be performed by the method as described above, but, as another example, it is also possible to perform estimation during the operation. Also in this case, it is possible to perform the estimation based on a timing of reply to the instruction issued from the control device 20, or the like. This makes it possible to estimate the offset while performing the operation. When the offset is estimated while performing the operation, a time deviation occurred during the operation is estimated and this time deviation is stored in the adapter 210, resulting in that even in an operation for a long period of time, it becomes possible to perform control which absorbs the time deviation occurred during the operation.

As described above, by transmitting the signal which performs control to make the controlled device 30 send a reply, from the control device 20 to the controlled device 30 at an arbitrary timing, it is possible to estimate a phase shift of each of the controlled devices 30 based on a timing at which the reply to this signal is sent and a timing at which the signal is transmitted by the control device 20.

Note that even if the operation cycle or the like is estimated in a manner as described above, the deviation sometimes occurs in an actual operation. In order to respond to such a case, the operation cycle estimator 200 may also receive a sensor signal from the sensor 40 to further estimate the deviation and the operation cycle.

The control indication acceptor 202 accepts a control target value or an indication regarding what kind of control is performed, transmitted from the control target indication device 10. In accordance with the indication accepted by this control indication acceptor 202, the control signal with respect to each of the controlled devices 30 and the sensor 40 is issued, and transmitted to the device to be required.

The control processing generator 204 generates, based on the received control target value, the control signal for performing control of the controlled device 30. The control signal is a signal indicating an operation of the controlled device 30 and a state of motion of the controlled device 30 at an end position or the like. This control signal is transmitted, together with a delay characteristic, to the adapter 210 corresponding to each of the controlled devices 30.

The exception handling executor 206 performs exception handling when an exception is occurred in the device connected to the control device 20. For example, in a case where an accident or a trouble occurs such as a case where an operation state of the controlled device 30 exceeds a safety range, or a case where the plural controlled devices 30 may collide with each other, the exception handling executor 206 executes the exception handling to prevent the accident or the like from occurring. A situation to be a cause of performing the exception handling may also include, other than the above, a situation regarding communication such as a timing deviation due to communication abnormality or absence of response with respect to communication. Further, it is also possible to include a generally dangerous situation.

The program storage 208 stores a program for operating the control device 20, and so on. The program storage 208 may be configured by including a volatile memory or a nonvolatile memory. Further, this storage may also store a program for performing not only the operation of the control device 20 but also the control of the controlled device 30 or the like.

The adapter 210 is an interface for connecting the controlled device 30 and the like and the control device 20, and one adapter 210 is provided with respect to each of the controlled devices 30. As another example, it is also possible to design such that the plural controlled devices 30 and the like and the control device 20 are connected by one adapter 210. In this case, it is also possible to design such that by setting a predetermined communication protocol, judgment can be made regarding to which controlled device 30 the communication is made. This adapter 210 transmits, to the controlled device 30, the control signal generated by the control processing generator 204 and describing an operation to be executed by the controlled device 30, based on the delay characteristic of the device.

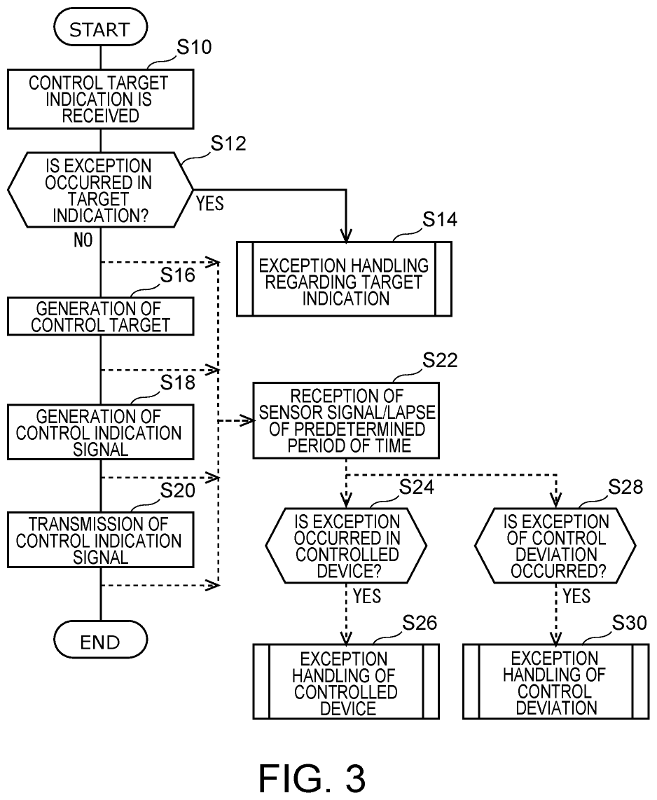

Next, an operation of the control device 20 will be described. FIG. 3 is a flow chart illustrating one example of the operation of the control device 20 according to the present embodiment. Note that the present flow chart illustrates, for example, an operation according to one loop in loop processing, and it is set that when such an operation is repeatedly conducted, an operation target of the system 1 is achieved.

Before the operation of this flow chart, it is also possible that the operation cycle estimator 200 estimates a control cycle of each device of the control target indication device 10, the controlled device 30, and the sensor 40. The operation cycle estimator 200 may collectively estimate, other than the cycles, a delay in the communication path, and/or a phase shift for each of the controlled devices 30. For these parameters, previously measured parameters may also be used. Further, the operation cycle estimator 200 may also estimate again the control cycle of each of the devices at a predetermined timing. In the adapter 210 corresponding to each of the controlled devices 30, information regarding the control cycle, the communication delay, and the phase shift is stored.

First, the control indication acceptor 202 receives the control target indication from the control target indication device 10 (step S10). The control target indication device 10 generates an indication to be a target regarding an operation that is performed in the system 1, and transmits the indication to the control indication acceptor 202 of the control device 20. The indication to be the target is, for example, an indication indicating to what kind of state the controlled device 30 is made to transit in the future in order to make a state in the system 1 to be a targeted state. This indication is generated by using a leaned model or by actually performing learning based on the state of the controlled device 30 at the timing, for example. For instance, the generation of this indication takes a period of time of 100 milliseconds.

Next, the control indication acceptor 202 after receiving the control target indication judges whether or not there is an exception in the reception of the control target indication (step S12). Specifically, the control indication acceptor 202 judges whether or not the control target indication can be received exactly according to a predetermined timing. When the control target indication cannot be received exactly according to the predetermined timing, this means that, for example, in a case where the control target indication device 10 issues the indication of the control target to the control device 20 every 100 milliseconds, the control target indication cannot be received at a timing of every 100 milliseconds, and it is determined whether or not the reception can be performed. Note that at this time, there is a possibility that a time deviation occurs depending on a communication state and states of various devices, so that it is also possible to provide a temporal margin in a manner that the reception can be performed not after 100 milliseconds but for 120 milliseconds from the previous reception.

When the control target indication cannot be received exactly according to the predetermined timing (step S12: Yes), the control device 20 performs exception handling regarding the control target indication (step S14). The exception handling is executed by the exception handling executor 206.

This exception handling may also be linearly extrapolated with respect to the control target up to the previous time, for example. As another example, it is also possible to perform control in a safe direction, namely, it is possible to perform extrapolation so as to suppress motion rather than performing linear interpolation with respect to the control target up to the previous time. Depending on the state of each of the controlled devices 30, an accident such as collision may occur by performing the extrapolation. In such a case, it is also possible to design such that the control in a safer direction is performed, and a control signal is generated so as to make the controlled device 30 smoothly stop its motion.

When the control target indication can be received exactly according to the predetermined timing (step S12: No), the control processing generator 204 generates the control target (step S16). The control target is generated by considering what kind of operation of the controlled device 30 is performed from a current state toward a future to reach the control target generated by the control target indication device 10.

For example, from a current position to a reaching position to be the control target, the control processing generator 204 calculates how much the controlled device 30 advances in the next control cycle of the controlled device 30, and generates the control target regarding the control cycle of the controlled device 30. More concretely, when a position to be the control target is indicated by the control target indication device 10, the control processing generator 204 generates the control target indicating which position is set to the reaching target in the next control cycle of the controlled device 30. For example, the control processing generator 204 generates the reaching target in the next control cycle of the controlled device 30 as the control target so that the controlled device 30 can move to the current control target up to when the next control target indication reaches.

Next, the control processing generator 204 generates a control indication signal regarding an operation of the controlled device 30 up to the generated control target (step S16). For example, when the position to be the control target in the control cycle of the controlled device 30 is indicated, the control processing generator 204 generates a signal which makes the controlled device 30 linearly move in accordance with the control cycle of the controlled device 30. As another example, when there exists a position to be a start of operation or an end of operation during a period of time from when the control target indication is reached to when the next control target indication is reached, it is also possible to generate a control signal which does not make the controlled device 30 move linearly but makes the controlled device 30 gradually start moving or gradually stop moving in the vicinity of the position.

This control signal is generated based on a program stored in the program storage 208, for example. When the moving position is designated, it is judged what kind of movement is made in a three-dimensional space, and a program regarding the movement is extracted from the programs stored in the program storage 208. Subsequently, a required parameter such as a moving direction or a moving distance is set, to thereby generate the control signal.

At this time, when the program stored in the program storage 208 is described by the DSL, it is possible to directly set the parameter to generate the signal. Besides, it becomes easy to combine different kinds of plural operations. It is needless to say that the program is not required to be described by the DSL, and there is no problem if the program is described by a computer language of another design concept.

Note that the control target and the control signal in step S16 and step S18 are not limited to those generated based on the position of the control target and the position of the controlled device 30. For example, it is also possible to employ a control signal related to electricity and electric power required for control such as a value of voltage and a value of current applied to the controlled device 30, a control signal related to rotation and force such as a rotation angle and torque of the controlled device 30, or a control signal related to a temperature or the like of the controlled device 30. Other than the above, when the controlled device 30 is an arm and is provided with plural finger parts, it is also possible to generate a control signal regarding motions of the finger parts in the arm, or the like. As described above, as long as the control signal related to the operation of the controlled device 30 is generated, it is possible to respond to any signal. Besides, operations as a result of combining the above-described plural operations may also be employed.

Next, the control signal with respect to each of the controlled devices 30 is transmitted to each of the controlled devices 30 based on the delay time or the like set in the adapter 210 (step S20). Based on the information regarding the communication delay and the information regarding the phase shift for each of the controlled devices 30 stored in the adapter 210, the generated control signal is transmitted from the control device 20 to the controlled device 30.

Explanation will be made by using an example illustrated in FIG. 1. There exists a phase shift of 3 milliseconds between the controlled device 30A and the controlled device 30B. Accordingly, in the adapter 210 corresponding to the controlled device 30A, the communication delay is set as 0 milliseconds, the control cycle is set as 10 milliseconds, and the phase shift is set as 0 milliseconds and, on the other hand, in the adapter 210 corresponding to the controlled device 30B, the communication delay is set as 0 milliseconds, the control cycle is set as 4 milliseconds, and the phase shift is set as 3 milliseconds.

When the setting is made as described above, in step S20, the control signal of the controlled device 30B is first transmitted to the controlled device 30B, and after 3 milliseconds of the transmission, the control signal of the controlled device 30A is transmitted to the controlled device 30A. In FIG. 1, since each of the communication delays regarding the controlled device 30A and the controlled device 30B is 0 milliseconds, the control related to the communication delay is not performed in particular, but, when there is a difference in the communication delay, a signal which is generated to be able to absorb even this communication delay, is transmitted. Such a signal is transmitted to the controlled device 30A every 10 milliseconds, and the signal is transmitted to the controlled device 30B every 4 milliseconds. As described above, the control device 20 transmits the control signal based on the communication delay, the control cycle, and the phase shift so that the controlled device 30A and the controlled device 30B cooperate to perform operations.

Note that when the controlled device 30 is operated for a long period of time, an error of about 100 ppm sometimes occurs. In this case, there is a case where when the controlled device 30 is operated for 10 seconds, an error of about 1 millisecond occurs. Such an error may be estimated by the operation cycle estimator 200 or the like based on the feedback signal from the controlled device 30 or the signal detected by the sensor 40 and set in the adapter 210 corresponding to the controlled device 30 in which the error is occurred.

The control device 20 performs the operation from the reception of the control target indication to the transmission of the control signal to each of the controlled devices 30 based on the operation from step S10 to step S20 as described above.

During the performance of the operation of the respective steps, the control device 20 receives the signal from the sensor 40 as needed (step S22). The sensor 40 transmits the detected information to the control device 20 in each control cycle of the sensor 40, for example. When the sensor 40 is a camera, it may transmit one piece of image data to the control device 20 every 10 milliseconds being the operation cycle, or it may transmit one piece of image data to the control device 20 every 100 milliseconds, for example, in accordance with a transfer rate and a processing speed. Alternatively, the sensor 40 may take a photograph in a span of a state of the controlled device 30 which is required to be grasped, and transmit image data. When the sensor 40 is not the camera, it is also possible that information detected by the sensor 40 is transmitted at an appropriately proper timing.

Further, there can be considered a case where the sensor signal cannot be received due to a trouble of the sensor, the communication abnormality, and so on. In order to respond to such a case, in addition to the reception of the sensor signal, the processing of step S22 and thereafter may be performed also in a case where the communication from the sensor cannot be received and a lapse of a predetermined period of time occurs. The predetermined period of time may be set to a period of time of 1.5 times a cycle in which the signal is transmitted from the sensor, or the like, for example. The period of time of 1.5 times is one example, and the period of time of 2 times or the like may be employed, which is a sufficient period of time for absorbing a communication delay, or on the contrary, the period of time of 1.2 times or the like may also be employed so that even the communication delay can be detected. The period of time is not limited to this, and the predetermined period of time may be set separately from the cycle in which the signal from the sensor is transmitted.

Next, the control device 20 determines whether or not an accident or the like to be an exception in the controlled device 30 is occurred in the received sensor signal (step S24). When the exception is not occurred (step S24: No), the control device 20 continues the existing processing (for example, any processing between step S10 and step S20).

On the other hand, when the accident or the like to be the exception is occurred in the controlled device 30 (step S24: Yes), the exception handling of the controlled device is executed (step S26). This exception handling can take place when the generation of control indication is not in time, for example. Accordingly, a program regarding the operation of the controlled device 30 which is transmitted to the controlled device 30 when the generation of control indication is not in time, is stored in the program storage 208. In a case where the generation of control indication is not in time and the next operation of the controlled device 30 cannot be decided, or the like, the program for exception handling stored in the program storage 208 is called and transmitted to the controlled device 30 as a control signal. Note that this control signal may also be transmitted without considering the communication delay, the phase shift, and the like. At this time, a severity parameter may be prepared, and it is possible to design such that the severity is increased when the generation of control signal is not in time in a continuous manner. Further, it is possible to change the control signal to be transmitted as the exception handling, based on the magnitude of severity.

The exception handling may be executed also in a case where the control of various devices including the controlled device 30 is deviated in a temporal direction (jitter is occurred) or deviated in a spatial direction (a control error is occurred) concurrently with the detection of exception in the controlled device 30. In the exception handling with respect to the control deviation, the sensor signal is first received to judge whether or not the exception of control deviation is occurred (step S28). When the control deviation is not occurred (step S28: No), the control device 20 continuously performs the existing processing in a similar manner to the above.

On the other hand, when the control deviation to be the exception is occurred in the controlled device 30 or the like (step S28: Yes), the exception handling of control deviation is executed (step S30). This exception handling can take place when, for example, a communication delay occurs for some reason, the control is not in time in the controlled device 30, or the operation is performed more than the operation to be controlled due to overshoot or the like in the controlled device 30. Accordingly, a program regarding the operation of the controlled device 30 which is transmitted to the controlled device 30 in such a case, is stored in the program storage 208, similarly to the above.

In a case as described above, the program for exception handling stored in the program storage 208 is called and transmitted to the controlled device 30 and the like as a control signal. Note that this control signal may also be transmitted without considering the communication delay, the phase shift, and the like. At this time, it is also possible to design such that a severity parameter similar to the above is used, and the exception handling to be executed is changed based on the severity. This severity parameter may be set to the same severity or it may also be calculated as separate severities between the exception handling of the controlled device and the exception handling of the control deviation.

As described above, the control device 20 receives the control target indication to make the controlled device 30 operate based on the control target, and further, when there is a possibility that an accident or the like occurs, the control device 20 makes the controlled device 30 execute the exception handling so as to prevent the accident or the like from occurring.

Note that whether the operation of the controlled device is controlled in a complementary manner or the controlled device is stopped safely as the exception handling, may be judged based on the number of times of occurrence of the exception, for example. The exception is, for example, the delay of reception of the control target indication, the delay of generation of the control signal with respect to the controlled device, and the occurrence of temporal deviation of the operation of the controlled device or the spatial deviation of the operation of the controlled device, as described above.

For example, when the number of times of occurrence of the exception is equal to or less than the predetermined number of times, the control is performed through complement, and when the number of times of occurrence of the exception exceeds the predetermined number of times, the controlled device is stopped safely. The number of times of occurrence of the exception may be set to the number of times at which the exception is occurred in a continuous manner, the number of times of occurrence of the exception within a predetermined period of time, or the cumulative number of times of occurrence of the exception from when the control device 20 starts the control.

The controlled device 30 that performs the exception handling may be set to all of the controlled devices 30 or a part of the controlled devices 30. For example, when an operation of a part of the controlled devices 30 exerts small influence on the other controlled devices 30, it is possible that the operation of the part of the controlled devices 30 is performed and the exception handling is performed with respect to the operation of the other controlled devices 30. In any case, the exception handling is performed so that a part or all of the controlled devices 30 can safely operate in a cooperative manner.

Note that in FIG. 3, the respective pieces of processing are illustrated as the operations in series, but, they are not limited to this and may be performed as parallel processing. For example, each of the reception of the control target indication and the generation of the control target, the generation and transmission of the control indication signal, and various kinds of exception handling may be operated as a forked separate process. The judgment of the occurrence of the exception may also be executed by daemon, for example. The indication with respect to each of the controlled devices 30 is an independent one, so that for each of the controlled devices 30, a child process in accordance with the operation cycle of the controlled device 30 may also be executed in a parallel manner.

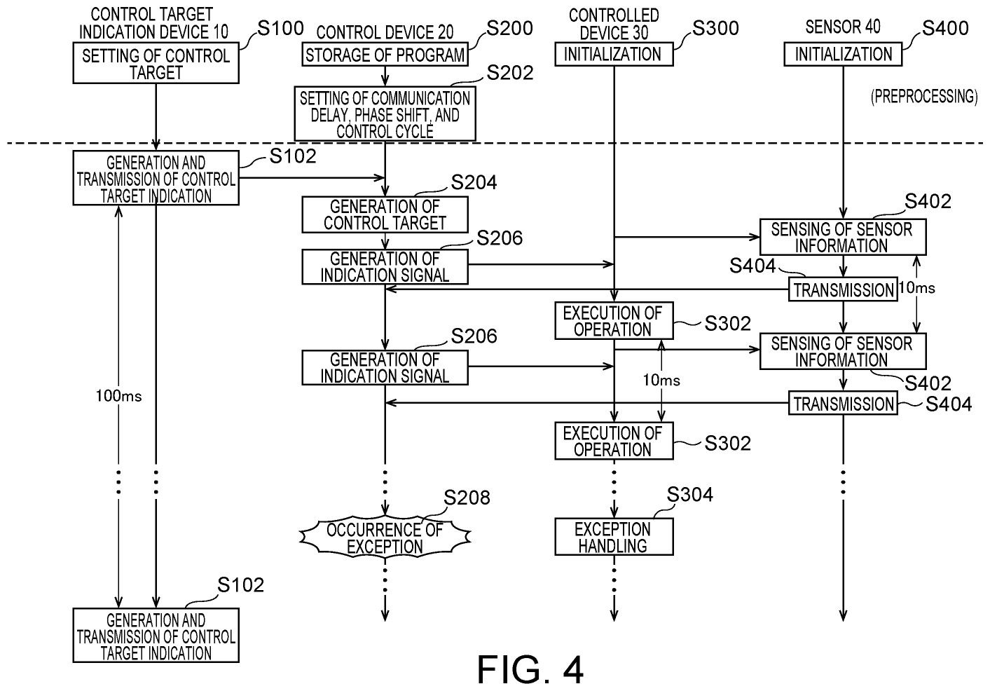

FIG. 4 is a diagram illustrating one example of a flow of processing including the control target indication device 10, the control device 20, the controlled device 30, and the sensor 40.

First, each device performs predetermined processing as preprocessing. The control target indication device 10 sets the control target (step S100). The setting of the control target is performed when, for example, a user inputs a task or the like to be executed by the system 1. The present embodiment is not limited to this, and it is also possible that the control target indication device 10 or the like automatically sets the control target. Further, it is also possible that the control target indication device 10 sets the control target based on the task or the like input by the user.

The control device 20 stores the various programs to be executed in the control device 20 (step S200). The programs may be stored by performing downloading from a previously determined file server or the like, or they may also be previously stored in the program storage 208 in the control device 20. Subsequently, the control device 20 uses the operation cycle estimator 200 to estimate the communication delay time, the phase shift time, and the control cycle with respect to the control target indication device 10, the controlled device 30, and the sensor 40 in an initial state, and sets those as the delay time and so on regarding each of the devices (step S202).

The controlled device 30 performs initialization (step S300). The initialization means an operation such that a parameter value is reset to be returned to an initial value, or a position of the controlled device 30 is returned to an initial state. Further, information regarding various parameters and the like in the initialized state may be transmitted to the control device 20, or the initial values may be previously set in the control device 20. The controlled device 30 after terminating the initialization may transmit a signal indicating the termination of initialization to the control device 20.

The sensor 40 performs initialization as well (step S400). In a similar manner to the controlled device 30, the initialization means an operation such that a parameter value is reset to be returned to an initial value, or a state of the sensor 40 is turned into a sensing state (standby state). The sensor 40 may transmit notification that it is turned into the standby state, to the control device 20.

After the initialization of the various devices as described above is completed, the system 1 starts the operation with respect to the control target.

First, the control target indication device 10 generates the control target indication, and transmits the generated control target indication to the control device 20 (step S102). The control target indication is generated based on the control target set in step S100 and the state of the controlled device 30 at the timing of generation. For example, the control target indication is generated so that an operation continued from the control target indication generated in a previous operation cycle is performed. Further, as another example, when each of the controlled devices 30 is normally controlled in accordance with the control target indication generated in the previous operation cycle, the control target indication is generated as a continuation from a reaching point in the control target indication generated in the previous operation cycle.

At this time, when the exception handling is occurred, it is also possible to generate the control target indication continued from the performance of the exception handling operation. In this case, the control target indication device 10 may receive what kind of control signal of the exception handling is transmitted to the controlled device 30 from the control device 20.

The control device 20 after receiving the control target indication generates the control target with respect to each of the controlled devices 30 (step S204). As illustrated in FIG. 1, in a case where the operation cycle of the control target indication device 10 is 100 milliseconds and the operation cycle of the controlled device 30A is 10 milliseconds, when the control device 20 receives one time of the control target indication, it generates the control target of each of the controlled devices 30 divided every 10 milliseconds, for example.

When, for example, a reaching point after 100 milliseconds is designated as the control target indication, it is possible to design such that the reaching point is divided into ten equal parts and the reaching point of every 10 milliseconds is generated as the control target, or the control target is generated so as to moderate the operation in the vicinity of the start of the operation and the end of the reaching point. It is not required that the control target of each of the controlled devices 30 corresponding to the whole period of time which is expected after the reception of the control target indication up to when the next control target indication is received, is generated, and the control target may also be sequentially generated based on the state of the controlled device 30 received from the sensor 40.

Next, the control device 20 generates an indication signal based on the generated control target, and transmits the indication signal to the controlled device 30. This signal is transmitted to the controlled device 30 by taking the communication delay and the phase shift with respect to the operations of the plural controlled devices 30 (a time deviation from when the signal is received to when the operation is started) into consideration.

The controlled device 30 after receiving the indication signal executes the operation based on the received indication signal (step S302). The delay due to the communication and the operation timing deviation with the other controlled devices 30 due to the phase shift are absorbed by the control device 20 as described above, so that the controlled device 30 is only required to simply execute the operation based on the received indication signal.

The generation and transmission operation of the indication signal of the control device 20 and the operation of the controlled device 30 are repeatedly executed by loop processing.

During such loop processing, the sensor 40 senses sensor information independently from each of the controlled devices 30 (step S402), and transmits the sensed sensor signal to the control device 20 (step S404). Since the operation cycle, the communication delay, and the phase shift of the sensor 40 are already estimated as well, by using these pieces of information as feedback information, it becomes possible to estimate the deviation of the operation of the controlled device 30 and the like. The estimated delay information or the like is described as needed in the corresponding adapter 210, which enables the control device 20 to transmit the control signal generated at a more accurate timing to each of the controlled devices 30.

The control device 20 monitors whether or not the exception is not occurred, based on the reception situation of the control target indication, the feedback signal from the controlled device 30 or the sensing signal from the sensor 40. When the exception is occurred (step S208), the control device 20 transmits a control signal for performing the exception handling to each of the controlled devices 30.

Each of the controlled devices 30 after receiving the control signal performs the operation of exception handling based on the control signal (step S304). At this time, the controlled device 30 side is not required to judge whether or not the received signal is the signal related to the exception handling, and it is only required to perform the operation based on the received control signal.

As described above, when generating the control signal related to the exception handling, the control device 20 judges whether the operation is continued or the operation is terminated after the exception handling. When the operation is continued, the control device 20 may transmit a reaching position and the like after the exception handling to the control target indication device 10, to correct the setting of the control target indication. By designing as described above, it is also possible to receive, as a new control target indication, a control target indication corresponding to one after the occurrence of exception handling. In this case, since there is a possibility that a processing delay occurs up to when the new control target indication is generated, it is also possible to design such that the operation up to when the new control target indication is received is appropriately complemented by the control device 20 based on the control target indication received before.

When the operation is terminated by the exception handling, the control signal which enables the controlled device 30 to stop safely is generated, to thereby control the controlled device 30. At this timing, control may also be made so that the controlled device 30 transmits information regarding various parameters and the like at a point of time at which the controlled device 30 is stopped. Further, it is also possible to perform control so that the various parameters and the like are initialized after the operation is stopped.

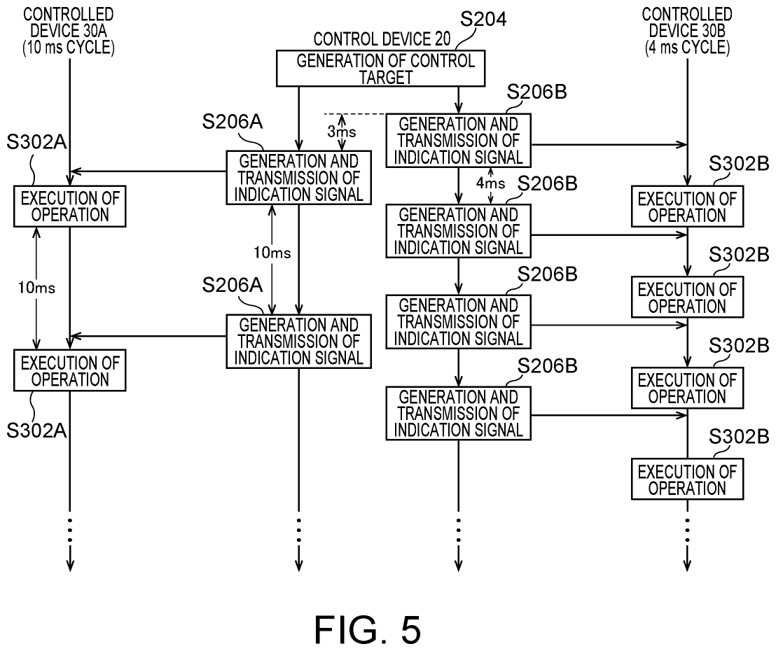

As illustrated in FIG. 4, the control target indication device 10, the controlled device 30, and the sensor 40 perform operations separately and individually, and the control device 20 centrally controls these operations without transmitting/receiving a synchronization signal. FIG. 5 is a diagram illustrating generation and transmission of indication signals when the operation cycles and so on are different between the controlled devices 30, and execution of the operations of the controlled devices 30.

It is set that the controlled device 30A has the operation cycle of 10 milliseconds and the phase shift of 0 milliseconds, and the controlled device 30B has the operation cycle of 4 milliseconds and the phase shift of 3 milliseconds. The control device 20 generates the control target in accordance with the above-described procedure (step S204). Next, the control device 20 generates the indication signal with respect to each of the controlled devices 30. Note that although FIG. 5 is illustrated such that the generation and the transmission of the indication signal are performed at the same timing, the present embodiment is not limited to this, and it is also possible to design such that the indication signal is generated in advance, and a transmission timing is deviated in accordance with the description in each of the adapters 210 corresponding to each of the controlled devices 30.

The generated indication signal with respect to the controlled device 30B is first transmitted to the controlled device 30B having the phase shift that is lagged relative to that of the controlled device 30A, in accordance with the description in the adapter 210 corresponding to each of the controlled devices 30 (step S206B).

Subsequently, at a timing deviated by the amount of phase shift, the control device 20 transmits the indication signal with respect to the controlled device 30A to the controlled device 30A (step S206A). By performing the transmission of indication signal while taking the phase shift into consideration as described above, the controlled device 30A and the controlled device 30B cooperate to start operations (step S302A, step 302B).

Subsequently, with respect to each of the controlled device 30A and the controlled device 30B, the control device 20 repeatedly performs the generation and the transmission of the indication signals in accordance with the operation cycles of the respective devices (step S206A, step S206B). As described above, the controlled device 30A and the controlled device 30B can perform a cooperative operation without transmitting/receiving a synchronization signal to/from each other, without transmitting/receiving a synchronization signal to/from the control device 20, in a cooperative manner in accordance with the operation cycles, and in which even the mutual phase shift is absorbed.

Based on the feedback signal of each of the controlled devices 30 and the sensor sensing signal of the sensor 40, the control device 20 appropriately and properly corrects the temporal deviation such as the phase shift and the spatial deviation. In a manner as described above, the cooperative operation of the respective controlled devices 30 is continued also in the operation for a long period of time.

Note that although the communication delay is not taken into consideration in FIG. 5, it is needless to say that the communication delay can also be processed similarly to the phase shift.

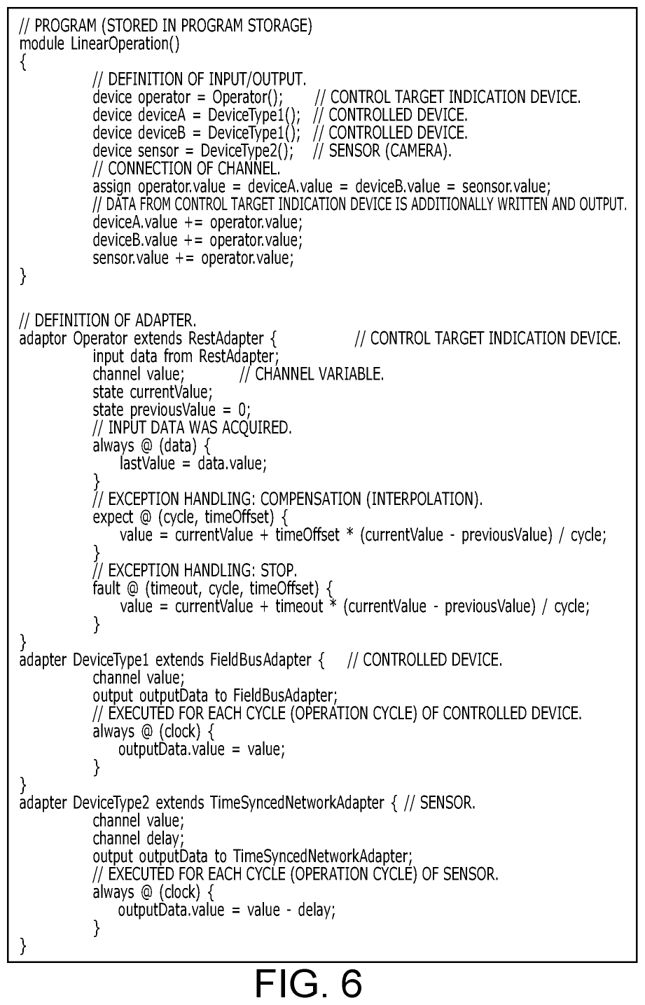

Next, a concrete implementation example of the exception handling will be described by using pseudo-codes. FIG. 6 is a diagram illustrating pseudo-codes regarding processing including the exception handling.

FIG. 6 illustrates pseudo-codes indicating processing of performing linear interpolation as one example of complementary processing. In a module LinearOperation( ) a module to be subjected to linear interpolation is described. After defining variables of various inputs/outputs and classes, each device is connected to a channel. In this example, it is set that there is no phase shift between deviceA and deviceB each being the controlled device 30, there is no communication delay between the controlled device 30 and the control device 20, and there exists delay being a communication delay between the sensor 40 and the control device 20.

To each device, the control signal is transmitted based on the communication delay and the like described in the adapter 210. By the description in the adapter 210 and the transmission timing of the control signal, the control target indication device 10, the mutual controlled devices 30, and the sensor 40 can execute a cooperative operation with high real-time property without transmitting/receiving a synchronization signal to/from one another.

FIG. 6 illustrates the exception handling when, in the control device 20, the delay depending on the control target indication device 10 is detected such as a case where the indication from the control target indication device 10 is delayed, as one example. As a definition of the adapter, the exception handling is described in the adapter of Operator being a variable of the control target indication device 10.

When the operation is continued as the exception handling in a case where the control target indication is not received, by setting that value=currentValue+timeOffset*(currentValue−previousValue)/cycle, a value after timeOffset is linearly extrapolated based on a difference between a current value and a value of a previous cycle, and as a target in a cycle of each of the controlled devices 30 and the sensor 40, extrapolation is performed by setting that deviceA·value+=operator·value, for example.

When performing safe stop as the exception handling in a case where the control target indication is not received, by setting that value=currentValue+timeOut*(currentValue−previousValue)/cycle, the controlled device 30 and the sensor 40 are stopped safely during when a period of time of timeOut value elapses.

In a manner as described above, by describing the communication delay, the phase shift, and the like as the definition of the adapter, it becomes possible to perform a cooperative operation with high real-time property without performing transmission/reception of a synchronization signal.

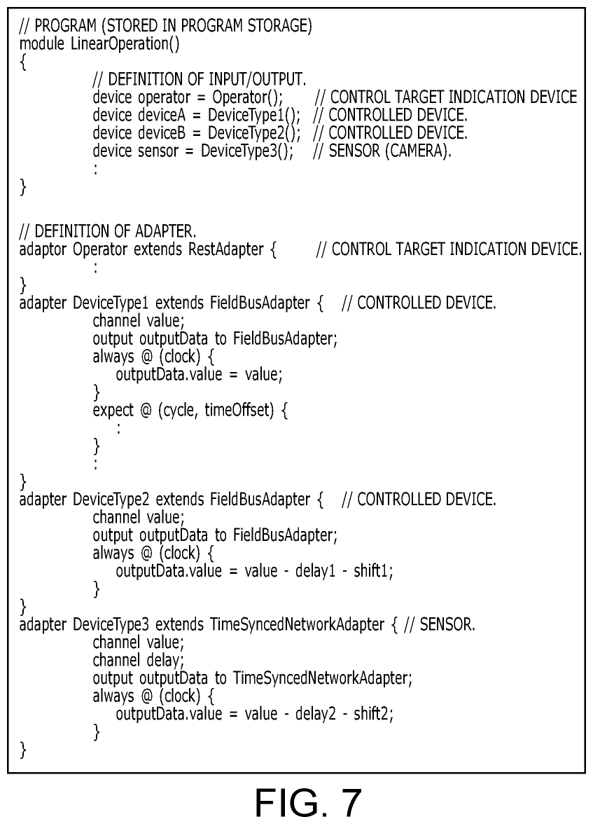

Note that in the example of FIG. 6, the state where there is no phase shift and the like between the deviceA and the deviceB each being the controlled device 30 is illustrated, but, the present embodiment is not limited to this. FIG. 7 is a diagram illustrating another example of pseudo-codes.

As illustrated in FIG. 7, it is also possible to separately set the adapter definitions of the deviceA and the deviceB each being the controlled device 30. In the example of FIG. 7, differences of delay1 being a communication delay and shift1 being a phase shift occur between the deviceA and the deviceB, so that in an adapter definition of DeviceType2 being a device type of the deviceB, value=value−delay1−shift1; is set, and a control signal is transmitted by absorbing these delays and the like. When there exists the phase shift similarly in the sensor as well, the definition of adapter is performed as in FIG. 7.

Further, although the exception handling ascribable to the control target indication device 10 is described in FIG. 6, when the exception handling inherent to DeviceType1 is caused, for example, it is also possible to describe the exception handling in an adapter definition of the DeviceType1. In a manner as above, it is also possible to describe the exception handling inherent to each device.

As described above, as the reasons for causing the exception handling, for example, there can be cited a situation where devices collide with each other, communication abnormality (communication failure), and the other situations which may generally cause dangers to a human being or a device. When communication is performed from operator for detecting the communication abnormality, it is possible to design such that a response signal, for example, a signal of ACK/NACK or the like is transmitted to the operator from the deviceA or the like through the adapter, or the operation of each device is analyzed based on an image photographed by a camera and the like to detect that no communication is performed. Further, it is also possible that the communication state is monitored to be detected by each device, the operator, or the like.

Specifically, as described above, when the number of times of occurrence of at least one of the delay of reception of the control target indication, the delay of generation of the control signal with respect to the controlled device, the temporal deviation of the operation of the controlled device, the spatial deviation of the operation of the controlled device, and the communication abnormality is equal to or less than the predetermined number of times, the control is performed by complementing the operation of the controlled device. On the other hand, when the number of times of occurrence of at least one of the delay of reception of the control target indication, the delay of generation of the control signal with respect to the controlled device, the temporal deviation of the operation of the controlled device, the spatial deviation of the operation of the controlled device, and the communication abnormality exceeds the predetermined number of times, the control of safely stopping the operation of the controlled device is performed.

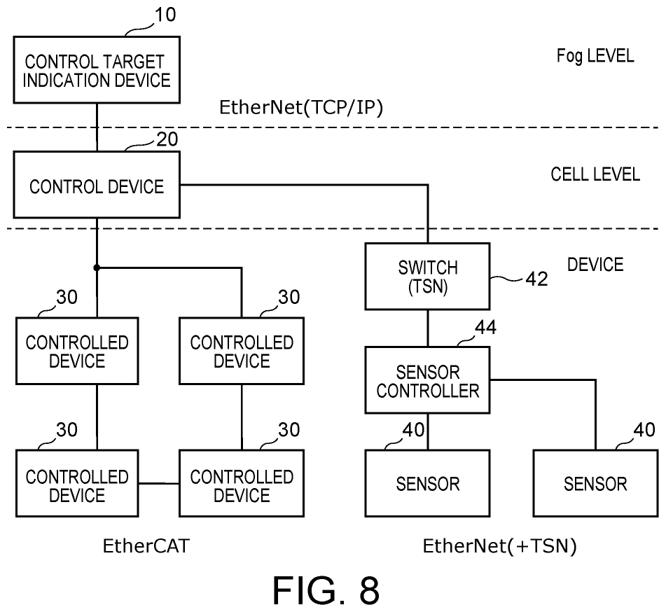

FIG. 8 is a diagram illustrating one example of concrete implementation of the present embodiment.

At a Fog level, the control target indication device 10 exists, and communication between the control target indication device 10 and the control device 20 is connected by Ethernet using TCP/IP. The communication between the control target indication device 10 and the control device 20 is not required to be communication with high real-time property, so that the normal communication using TCP/IP as described above may be used.

The control device 20 exists at a cell level, it is connected to each of the controlled devices 30 by EtherCAT (registered trademark), and it is connected to the sensor by Ethernet extended by TSN (Time-Sensitive Networking) capable of enduring communication with data amount greater than that of the communication with the controlled device 30, for example. When compared to the communication between the control device 20 and the control target indication device 10, the communication with higher real-time property is required between the controlled device 30 and the sensor 40, and the control device 20, so that the connection is made by the communication method using Ethernet extended as described above, for example.

The respective controlled devices 30 may be connected in a ring shape as illustrated in FIG. 8, or it is also possible that each of the plural controlled devices 30 is connected to the control device 20. The sensor 40 is connected to the control device 20 via a switch 42 and a controller 44. By using Ethernet extended by TSN, it is possible to endure the communication with large data amount, and at the same time, since low-delay communication is prioritized, it becomes possible to transmit sensing information with high real-time property to the control device 20.

By performing connection as described above, it becomes possible that the sensor 40 senses operation states of the plural controlled devices 30, and the sensed information is quickly transmitted to the control device 20. Further, as described above, it becomes possible to transmit the control instruction for each of the controlled devices 30 based on the control target indication generated by the control target indication device 10, without transmitting a synchronization signal.

As described above, according to the present embodiment, by estimating the operation cycle and so on of each of the controlled devices 30, describing the operation cycle and so on in the adapter 210 corresponding to each of the controlled devices 30, and transmitting the control signal by absorbing the delay, the shift, the latency, and so on such as the communication delay and the phase shift in the control device 20, the control of the plural controlled devices 30 in accordance with the control target indication generated by the control target indication device 10 can be executed, without performing transmission/reception of the synchronization signal, in a state where the communication with high real-time property (the communication between the controlled device 30 and the sensor 40, and the control device 20) and the other communication (the communication between the control target indication device 10 and the control device 20) exist in a mixed manner. By employing such a configuration, it becomes possible to generate a control target with higher accuracy in the control target indication device 10, and it becomes possible to perform control with high real-time property in the controlled device 30 and the sensor 40.

Note that all delays and so on in the system 1 can be absorbed in the control device 20, or a part of the delays and so on may be absorbed in the control device 20. When all delays and so on are absorbed in the control device 20, an external observation unit such as the sensor 40 is preferably provided. This is because the delay characteristic of each of the controlled devices 30 is analyzed by the control device 20 or a peripheral device based on a deviation between an indication state obtained by the external observation unit and a current indication state of each of the controlled devices 30, the delay characteristic is described in the adapter corresponding to each of the controlled devices 30 in the control device 20, and a program processor can generate an instruction sequence by using this delay characteristic. Here, the delay characteristic is a concept including not only a value and work delay but also a characteristic of each of the controlled devices 30 and the like. Further, each of the controlled devices 30 may also include a device such as the control target indication device 10 as a device that uses deep learning.

The DSL has a dynamic characteristic, particularly a characteristic of CPU time that is already confirmed by a dynamic test in which components thereof are configured in advance, and in an application logic combining the components by the DSL, it is apparent at what probability a desired real-time property is satisfied. Further, in controlled devices that are operated at shifted phases, devices with different cycles in the first place, devices with different delay characteristics or different jitter characteristics, and the like, it becomes possible to complement an intermediate value while guaranteeing a firm real-time property.

Besides, in preparation for a case where the desired real-time characteristic is not satisfied, a default strategy and an emergency strategy at an output data part with respect to a device are defined. The default strategy and the emergency strategy are operated in embedded hard real-time processing, and are selected when control in real-time is not in time and the operation is performed as firm real-time. When the default strategy is continued for a certain period of time or more, this is judged as an emergency, and by the emergency strategy, it becomes possible to perform safe stop. This makes it possible to guarantee the safety of the system itself and prevent troubles and so on of various devices in the system.

Although it is designed such that the control device 20 and the controlled device 30 are separately provided in the above-described embodiment, the embodiment is not limited to this. The control device 20 and the controlled device 30 may be provided in the same machine or the same device. Further, in this case, plural controlled devices may also be included in one device.

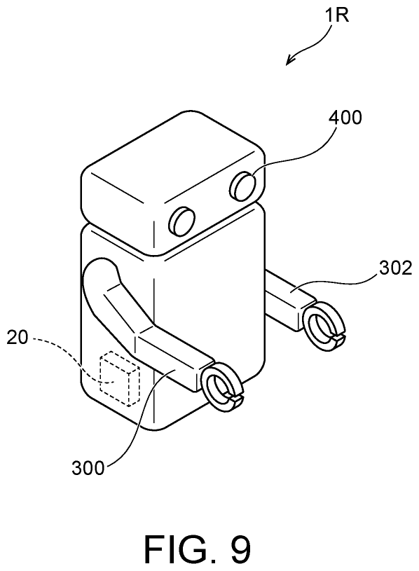

FIG. 9 is a schematic diagram illustrating one example of implementation. For example, the system 1 is provided inside one robot 1R. Even in a case where plural controlled devices 30 whose control cycles are not synchronized are provided in the robot 1R, it is possible to apply the above-described embodiment.

For example, to each of the controlled devices 30, a sensor and an actuator are connected, and the respective controlled devices 30 execute a control loop for realizing mission-critical processing. When the sensors and the actuators that belong to different controlled devices 30 perform a cooperative operation, by applying the present embodiment, it is possible to execute correction of deviation of the control cycle, and the measuring cycle of each sensor, absorption of fluctuation of the processing time and the communication delay, and so on. By performing the above correction and so on, it is possible to realize a real-time property when operating the robot 1R.

When the processing time, the communication delay, or the like exceeds a predetermined threshold value, for example, when the processing time, the communication delay, or the like exceeds a predetermined period of time, processing for safely stopping the previously defined cooperative operation work may be executed for each of the controlled devices 30. As described above, when, during this processing, the exception of the previously defined processing is occurred, emergency stop may be performed.

For example, as illustrated in FIG. 9, the robot 1R includes arms 300, 302 being two controlled devices. These arms 300, 302 can perform a cooperative operation. When a cooperative operation to grip one object is performed, even when control cycles of the arms 300, 302 are not synchronized, by correcting a deviation of the control cycles regarding the respective controlled devices, the respective arm parts operate in a cooperative manner, to thereby realize the grip operation.

For example, when a large delay occurs in the communication with the arms 300, 302 being the controlled devices and the cooperative operation has to be stopped, if a sudden stop is performed, the object which is being gripped is sometimes damaged. In such a case, by previously defining exception handling in a program part, it is possible to define safe stop processing in accordance with the operations of the respective arms 300, 302 being the controlled devices. For example, by this definition, it is possible to moderately stop the arms 300, 302, to thereby perform processing without damaging the object.

As described above, the system 1, namely, the robot 1R may also include the sensor 40. For example, the robot 1R includes a camera 400. The sensor 40 and the controlled device 30 connected to the same control device 20 can also be respectively controlled according to the present embodiment, as described above. In one control device 20, a method of executing synchronization based on a control signal such as bus clock is generally employed, but, for example, in processing in which a calculated amount is variable and a calculation result is not fixed according to a clock cycle, or when a measuring cycle of the sensor is not fixed, it becomes possible to use synchronous processing using a correction value.

In the example of FIG. 9, one control device 20 can control the performance of gripping the object by using the arms 300, 302, based on a video acquired by the camera 400. Even if the arms 300, 302 and the camera 400 have different synchronization cycles, according to the present embodiment, the arms 300, 302 can be controlled based on the video from the camera 400, and even when the exception is occurred, it becomes possible to properly perform the cooperative operation.

Besides, the present embodiment can be applied also to a case where a robot is operated by remote control via a data communication network such as Internet. Also in a case where the communication delay is increased or a case where there is data missing, it is possible to perform system control with high real-time property. This makes it possible to reduce a possibility of causing abnormal circumstances such as emergency stop of the robot being an operation target, based on the previously defined exception handling. In a manner as described above, it is possible to continue even a mission-critical operation performed by the robot.

According to some embodiments, a control device further includes a control indication acceptor receiving a control target indication to be a target of the control regarding each of the controlled devices and a control processing generator generating a signal for performing control of an operation of the controlled device based on the received control target indication, wherein control of operations is performed so that each of the controlled devices cooperates to reach the target of control, based on a communication delay time, a phase shift time, and an operation cycle time regarding each of the controlled devices.

According to some embodiments, a control method further includes following steps: receiving a control target indication to be a target of the control regarding each of the controlled devices, generating a signal for performing control of an operation of the controlled device based on the received control target indication, and controlling of operations performed so that each of the controlled devices cooperates to reach the target of control, based on a communication delay time, a phase shift time, and an operation cycle time regarding each of the controlled devices.

According to some embodiments, a program which is executed by one or more processor to perform method includes following steps: receiving a control target indication to be a target of the control regarding each of the controlled devices, generating a signal for performing control of an operation of the controlled device based on the received control target indication, and controlling of operations performed so that each of the controlled devices cooperates to reach the target of control, based on a communication delay time, a phase shift time, and an operation cycle time regarding each of the controlled devices.

In the above entire description, at least a part of the system 1 may be configured by hardware, or may also be configured by software and a CPU (Central Processing Unit) and the like perform the operation based on information processing of the software. When it is configured by the software, it is possible to design such that a program which realizes the system 1, and at least a partial function thereof is stored in a storage medium such as a flexible disk or a CD-ROM, and read by a computer to be executed. The storage medium is not limited to a detachable one such as a magnetic disk or an optical disk, and it may also be a fixed-type storage medium such as a hard disk device or a memory. Specifically, it is possible to design such that the information processing by the software is concretely implemented by using a hardware resource. Besides, it is also possible to design such that the processing by the software is implemented by the circuitry of FPGA (Field-Programmable Gate Array) or the like and executed by the hardware. The generation of the learning model or processing after performing input in the learning model may be carried out by using an accelerator such as a GPU (Graphical Processing Unit), for example.

Further, the learning model according to the present embodiment can be utilized as a program module being a part of artificial-intelligence software. Specifically, the CPU of the computer operates to perform arithmetic operation on data detected by the sensor 40 or data to be an operation target based on a model stored in the control target indication device 10, and output a result from a learned model.

A person skilled in the art may come up with addition, effects, or various kinds of modifications of the present disclosure based on the above-described entire description, but, examples of the present disclosure are not limited to the above-described individual embodiments. Various kinds of addition, changes and partial deletion can be made within a range that does not depart from the conceptual idea and the gist of the present disclosure derived from the contents stipulated in claims and equivalents thereof.

1. A control device, comprising:
a control indication acceptor receiving a control target indication to be a target of control with respect to plural controlled devices; and
a control processing generator generating a control signal with respect to each of the plural controlled devices based on the control target indication, wherein
operations of the plural controlled devices are controlled so that the plural controlled devices cooperate to achieve the target, based on at least one of a communication delay time, a phase shift time, and an operation cycle time of the plural controlled devices.

2. The control device according to claim 1, wherein
the control is performed to make each of the controlled devices cooperate without outputting a synchronization signal to each of the controlled devices.

3. The control device according to claim 1, further comprising
an exception handling executor performing exception handling when at least one of a delay of reception of the control target indication, a delay of generation of the control signal with respect to the controlled device, a temporal deviation of an operation of the controlled device, and a spatial deviation of the operation of the controlled device is occurred.

4. The control device according to claim 3, wherein
when the exception handling executor performs the exception handling, it switches the exception handling to be executed, based on a frequency of operation causing the exception handling.

5. The control device according to claim 4, wherein:
when the number of times of occurrence of at least one of the delay of reception of the control target indication, the delay of generation of the control signal with respect to the controlled device, the temporal deviation of the operation of the controlled device, the spatial deviation of the operation of the controlled device, and communication abnormality is equal to or less than a predetermined number of times, the exception handling executor performs the control by complementing the operation of the controlled device; and
when the number of times of occurrence of at least one of the delay of reception of the control target indication, the delay of generation of the control signal with respect to the controlled device, the temporal deviation of the operation of the controlled device, the spatial deviation of the operation of the controlled device, and the communication abnormality exceeds the predetermined number of times, the exception handling executor performs the control to safely stop the operation of the controlled device.

6. The control device according to claim 3, wherein
the exception handling is performed based on at least one of information received from a sensor, the delay of the control signal, and the communication abnormality.

7. The control device according to claim 1, further comprising
an operation cycle estimator estimating an operation cycle of the controlled device.

8. The control device according to claim 7, wherein
the operation cycle estimator estimates the operation cycle of each of the controlled devices based on a timing at which a signal is transmitted to each of the controlled devices, and a timing at which a reply from each of the controlled devices is received.

9. The control device according to claim 7, wherein
the operation cycle estimator further estimates a communication delay and a phase shift with respect to the controlled device.

10. The control device according to claim 1, further comprising
an adapter storing the communication delay time, the phase shift time, and the operation cycle time regarding each of the controlled devices, and transmitting, based on the stored respective pieces of information, the control signal with respect to each of the controlled devices generated by the control processing generator, to each of the controlled devices.

11. The control device according to claim 1, wherein
the control target indication is generated based on a previously learned model.

12. The control device according to claim 1, wherein
the control target indication is generated by performing learning based on a control state of the controlled device and an operation state of the controlled device, concurrently with the control of the controlled device.

13. A system, comprising:
the control device according to claim 1; and
plural controlled devices which are controlled by the control device.

14. A control device controlling plural controlled devices, the control device comprising:
a control indication acceptor receiving a control target indication to be a target of the control regarding each of the controlled devices; and
a control processing generator generating a signal for performing control of an operation of the controlled device based on the received control target indication, wherein
control of operations is performed so that each of the controlled devices cooperates to reach the target of control, based on a communication delay time, a phase shift time, and an operation cycle time regarding each of the controlled devices.

15. A control method, comprising:
receiving a control target indication to be a target of control with respect to plural controlled devices;
generating a control signal with respect to each of the plural controlled devices based on the control target indication; and
controlling operations of the plural controlled devices so that the plural controlled devices cooperate to achieve the target, based on at least one of a communication delay time, a phase shift time, and an operation cycle time of the plural controlled devices.

16. A control method according to claim 15, wherein
the control is performed to make each of the controlled devices cooperate without outputting a synchronization signal to each of the controlled devices.

17. A control method according to claim 15, further comprising:
performing exception handling when at least one of a delay of reception of the control target indication, a delay of generation of the control signal with respect to the controlled device, a temporal deviation of an operation of the controlled device, and a spatial deviation of the operation of the controlled device is occurred.

18. A control method according to claim 17, wherein
when a exception handling executor performs the exception handling, it switches the exception handling to be executed, based on a frequency of operation causing the exception handling.

19. The control method according to claim 18, wherein:
when the number of times of occurrence of at least one of the delay of reception of the control target indication, the delay of generation of the control signal with respect to the controlled device, the temporal deviation of the operation of the controlled device, the spatial deviation of the operation of the controlled device, and communication abnormality is equal to or less than a predetermined number of times, the exception handling executor performs the control by complementing the operation of the controlled device; and
when the number of times of occurrence of at least one of the delay of reception of the control target indication, the delay of generation of the control signal with respect to the controlled device, the temporal deviation of the operation of the controlled device, the spatial deviation of the operation of the controlled device, and the communication abnormality exceeds the predetermined number of times, the exception handling executor performs the control to safely stop the operation of the controlled device.

20. The control method according to claim 17, wherein
the exception handling is performed based on at least one of information received from a sensor, the delay of the control signal, and the communication abnormality.
